(19) United States
(12) Patent Application Publication
(10) Pub. No.: US 2025/0226737 A1
(43) Pub. Date: Jul. 10, 2025

(54) Modular, Multicell, and Multilevel Inverter

(71) Applicant: BOARD OF REGENTS, THE UNIVERSITY OF TEXAS SYSTEM, Austin, TX (US)

(72) Inventors: Qin Huang, Austin, TX (US); Peng Han, Austin, TX (US); Rishab Anand, Austin, TX (US)

(21) Appl. No.: 19/014,996

(22) Filed: Jan. 9, 2025

Related U.S. Application Data
(60) Provisional application No. 63/619,229, filed on Jan. 9, 2024.

(51) Int. Cl. H02M 1/00; H02M 1/12; H02M 3/07; H02M 3/335; H02M 7/219; H02M 7/5387

(52) U.S. Cl. CPC H02M 1/007; H02M 1/126; H02M 3/07; H02M 3/33584; H02M 7/219; H02M 7/5387

(57) ABSTRACT

An exemplary Cascaded H-bridge or Modular Multilevel Converter/Inverter are disclosed that employ a H-bridge cell or half-bridge cell that includes a linking switch additionally employed between two H-bridge cells, i cell and i+1 cell, to allow a parallel number of cells to operate together. Each of the H-bridge cells includes the standard four switches and additionally the linking switch between two H-bridge cells. The system can beneficially have improved system conversion efficiency due to better DC energy source utilizations, e.g., for improved efficiency of converters that convert DC energy to AC energy. The cascading H-bridge cells (or half-bridge cells) can be configured as a charge pump converter, bidirectional 3-phase inverter, among other topologies.

### RELATED APPLICATION

This U.S. application claims priority to, and the benefit of, U.S. Provisional Patent Application No. 63/619,229, filed Jan. 9, 2024, entitled “Modular, Multicell, and Multilevel Inverter,” which is incorporated by reference herein in its entirety.

### GOVERNMENT RIGHTS

This invention was made with government support under 2234618 awarded by the National Science Foundation. The government has certain rights in the invention.

### SUMMARY

Cascaded H-bridge (CHB) and Modular Multilevel Converter (MMC) are two widely used modular, multicell, multi-level converters that use many lower voltage H-bridge cells (i.e., full bridge) or submodules to reach a higher voltage to connect to the grid or load. In the case of the MMC, a bridge cell is also frequently used. The multilevel sinusoidal output voltage can be generated by the CHB or MMC by independently controlling the output voltage of each cell. The sum of them needs to follow a sinusoidal reference V_{ref}.

In topologies like Cascaded H-bridge and Modular Multilevel Converter, during operation, when one cell is generating zero output voltage, the DC voltage source associated with that cell (i.e., battery, PV, or pure capacitor bank) is not absorbing nor injecting power to the grid or the load. In essence, it is bypassed and idle and results in poor resource utilization. In the case of a battery, for example, the bypassed or idle power can result in lower system efficiency because other cells generating +Vdc or −Vdc may have to work harder or be subjected to higher current stress for a given power level.

An exemplary Cascaded H-bridge or Modular Multilevel Converter/Inverter is disclosed that employs a H-bridge cell (or half-bridge cell) that includes a linking switch S₅ additionally employed between two H-bridge cells, i cell and i+1 cell, to allow a parallel number of cells to operate together. Each of the H-bridge cells includes the standard four switches S₁, S₂, S₃, S₄, and the linking switch S₅ between two H-bridge cells. The system can have improved system conversion efficiency due to better DC energy source utilizations, e.g., for improved efficiency of converters that convert DC energy to AC energy. In the case of energy storage systems, the exemplary system is expected, via simulations, to improve system efficiency by as much as 6%. In some embodiments, the H-bridge cell can be employed for a DC/DC converter.

For an N-cell CHB, a total N−1 linking-switch S₅ may be employed. The linking switch S₅ may block positive and negative voltages and, thus, can be realized by two MOSFETs or two IGBTs connected in the source-to-source or drain-to-drain configuration. The voltage stress on the linking switch S₅ equals the DC voltage source V_{dc}. When S₅ is “OFF,” Cell i and Cell i+1 may operate like a traditional H-bridge in a CHB or MMC. When S₅ is “ON,” the switch S_{3,i} and switch S_{1,i+1} of the two H-bridge cells may be “OPEN,” and the switch S_{4,i} and S_{2,i+1} of the two H-bridge cells may be “ON” to put the voltage across the DC source V_{dci} of the H-bridge cell i in parallel with the DC source V_{dci+1} of the next H-bridge cell i+1. The two H-bridge cells together may become a new H-bridge cell in which two voltage sources are in parallel, thus improving circuit efficiency since the current in each voltage source may decrease.

The exemplary Cascaded H-bridge or Modular Multilevel Converter can operate with a DC voltage source such as a battery, fuel cell, photovoltaic, or other types of DC source. In addition to stationary battery energy storage applications, it can be used in battery electric vehicles (BEV), photovoltaic, or other DC voltage-based systems.

In an aspect, a modular, multicell, multi-level power conversion system is disclosed comprising a set of cascading H-bridge cells, including a first H-bridge cell and a second H-bridge cell, each of the first and second H-bridge cell as a modular unit cell including four switches arranged in a H-bridge configuration; terminals to a DC power source (e.g., PV, energy storage, capacitor bank, etc.), the terminals located parallel to the H-bridge configuration; and a fifth switch connecting the modular unit cell to a next unit cell in the set of cascading H-bridge cells, wherein the fifth switch, along with the respective four switches of the modular unit cell and the next modular unit cell, are configured to collectively form a new H-bridge between them that links together the respective terminals to the DC power sources of the modular unit cell and the next modular unit cell in a parallel connection.

In some embodiments, the fifth switch is connected in series along a positive bus located between the first H-bridge cell and the second H-bridge cell.

In some embodiments, the fifth switch includes at least one of: (i) two MOSFETs or (ii) two IGBTs, arranged to block current flow in a first direction from the modular unit cell to the next modular unit and a second direction from the next modular unit cell to the modular unit.

In some embodiments, the fifth switch is connected in series along a negative bus located between the first H-bridge cell and the second H-bridge cell.

In some embodiments, the fifth switch is connected in parallel between the first H-bridge cell and second H-bridge cell.

In some embodiments, the system is configured as an N-cell CHB or N-cell MMC, the system including N−1 number of the fifth switches.

In some embodiments, a controller of the fifth switches is configured to, based on a target output voltage for a DC/AC conversion, direct a number of fifth switches to be enabled to link the respective terminals to the DC power sources of the modular unit cell and the next modular unit cell of the cascading network in parallel connections.

In some embodiments, cells of the set of cascading half-bridge cells are selected to operate based on equal utilization of the fifth switches.

In another aspect, a modular, multicell, multi-level power conversion system is disclosed comprising a set of cascading half-bridge cells, including a first half-bridge cell and a second half-bridge cell, each of the first and second half-bridge cell as a modular unit cell including two switches arranged in a half-bridge configuration; terminals to a DC power source, the terminals located parallel to the half-bridge configuration; and a third switch that connects the modular unit cell to a next modular unit cell in the set of cascading half-bridge cells, wherein the third switch and the respective two switches of the modular unit cell and the next modular unit cell are configured to operate to collectively form a new half-bridge between the modular unit cell and the next modular unit cell that links together the respective terminals to the DC power sources of the modular unit cell and the next modular unit cell in parallel connection.

In some embodiments, the terminals to the DC power source of the first half bridge cell are configured to couple to a DC source, and wherein the terminals to the DC power source of the second half bridge cell and the other half bridge cells are configured to couple to a DC capacitor, and the circuit is configured to form a charge pump DC/DC converter.

In some embodiments, the charge pump DC/DC converter includes a diode and a capacitor at the output of the last half-bridge cell.

In some embodiments, the terminals to the DC power source of the first half-bridge cell are configured to couple to a DC source, and wherein the terminals to the DC power source of the second half-bridge cell and the other half-bridge cells are configured to couple to a DC capacitor, and the circuit is configured to form a bi-directional charge pump DC/DC converter, wherein a switch and a capacitor is connected to the output of the last half bridge cell.

In some embodiments, the bidirectional charge pump DC/DC converter is configured as a boost converter when operating in a first current flow direction and as a buck converter when operating in a second current flow.

In some embodiments, the modular, multicell, multi-level power conversion system described herein further comprises a second charge pump DC/DC converter and a third charge pump DC/DC converter; and a 6-switch 2-level converter, wherein the 6-switch 2-level converter terminates the charge pump DC/DC converter, the second charge pump DC/DC converter, and the third charge pump DC/DC converter, as a 3-phase inverter, wherein the 6-switch 2-level converter is coupled to a single DC source, and wherein the converter is configured to operate as a DC/AC three-phase inverter with an output voltage higher than the DC source voltage.

In another aspect, a modular, multicell, multi-level power conversion system is disclosed comprising a set of cascading H-bridge cells, including a first H-bridge cell and a second H-bridge cell, each of the first and second H-bridge cell as a modular unit cell including four switches arranged in a H-bridge configuration; terminals to a DC power source, the terminals located parallel to the H-bridge configuration; and a fifth switch connecting the modular unit cell to a next unit cell in the set of cascading H-bridge cells, wherein the fifth switch, along with the respective four switches of the modular unit cell and the next modular unit cell, are configured to collectively form a new H-bridge between them that links together the respective terminals to the DC power sources of the modular unit cell and the next modular unit cell in a parallel connection; a first set of cascading H-bridge cells, including the first and second H-bridge cells, wherein the DC terminals of the first set of cascading H-bridge cells are connected to a respective capacitor bank; a second set of cascading H-bridge cells, including a third H-bridge cell and a fourth H-bridge cell, where the DC terminals of the second set of cascading H-bridge cells are connected to a respective capacitor bank; and an additional H-bridge cell that is coupled to a DC voltage source, wherein the first set of cascading H-bridge cells, the second set of cascading H-bridge cells, and the additional H-bridge cell collectively form an inverter.

In some embodiments, the modular, multicell, multi-level power conversion system described herein further comprises a grid filter on the AC side of the converter.

In some embodiments, a controller is configured to perform magnitude and frequency control for the modular, multicell, multi level power conversion system.

In some embodiments, the modular, multicell, multi-level power conversion system described herein further comprises a second inverter, and a third inverter, each of the second and third inverter including two sets of cascading H-bridge cells, including a first respective and a second respective cascading H-bridge cells; and an additional H-bridge cell that is coupled to a DC voltage source, wherein the inverter, second inverter, and third inverter are connected in a delta- or Y-configuration for 3-phase operation.

In some embodiments, the additional H-bridge cells DC terminal is coupled to a load, forming a single-phase AC/DC rectifier or three-phase AC/DC rectifier.

### BRIEF DESCRIPTION OF DRAWINGS

The components in the drawings are not necessarily to scale relative to each other. Like reference, numerals designate corresponding parts throughout the several views.

FIGS. 1A and 1B show examples of a modular, multicell, multi-level converter/inverter system configured with a H-bridge cell comprising an H-bridge connected by a linking switch to a next H-bridge cell to link voltage sources in the respective cell in accordance with an illustrative embodiment.

FIG. 2 shows an example operation of the modular, multicell, multi-level converter/inverter system configured to couple to a set of batteries as a voltage source and when one of the linking switches is enabled to force the parallel of two batteries.

FIG. 3 shows a simulation of the modular, multicell, multi-level converter/inverter system to drive a motor load.

FIGS. 4 and 5 show additional examples of the modular, multicell, multi-level converter/inverter system configured with a H-bridge cell comprising an H-bridge connected by a linking switch to a next H-bridge cell to link voltage sources in the respective cell in accordance with an illustrative embodiment.

FIG. 6 shows an example of the Modular Multilevel Converter system configured with a half-bridge cell in accordance with an illustrative embodiment.

FIG. 7A shows the Modular Multilevel Converter system of FIG. 6 configured as a unidirectional charge pump DC/DC converter in accordance with an illustrative embodiment.

FIG. 7B shows the Modular Multilevel Converter system of FIG. 6 configured as a bidirectional charge pump DC/DC converter in accordance with an illustrative embodiment.

FIG. 8A shows the CHB system of FIGS. 1A, 1B, 2, 3, and 4 configured as a bidirectional DC-AC and AC-DC inverter/rectifier in accordance with an illustrative embodiment. In FIG. 8A, only one cell contains a DC source (i.e., battery), while the other cells are just using DC capacitors.

FIGS. 8B and 8C show the bidirectional DC-AC and AC-DC inverter/rectifiers FIG. 8A configured for 3-phase operation in accordance with an illustrative embodiment.

FIG. 9 shows a bidirectional DC-AC and AC-DC inverter/rectifiers configured for 3-phase operation in accordance with an illustrative embodiment.

### DETAILED DESCRIPTION

It is appreciated that certain features of the disclosure, which are, for clarity, described in the context of separate aspects, can also be provided in combination with a single aspect. Conversely, various features of the disclosure, which are, for brevity, described in the context of a single aspect, can also be provided separately or in any suitable subcombination. Unless defined otherwise, all technical and scientific terms used herein have the same meaning as commonly understood by one of ordinary skill in the art. Methods and materials similar or equivalent to those described herein can be used in the practice or testing of the present disclosure.

### Example Systems with H-Bridge Cells

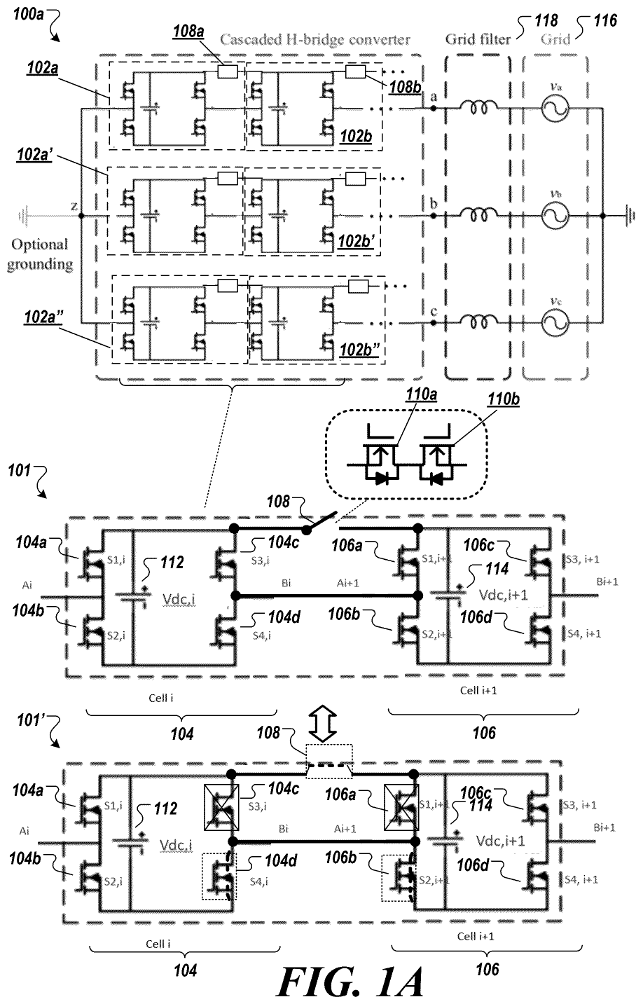

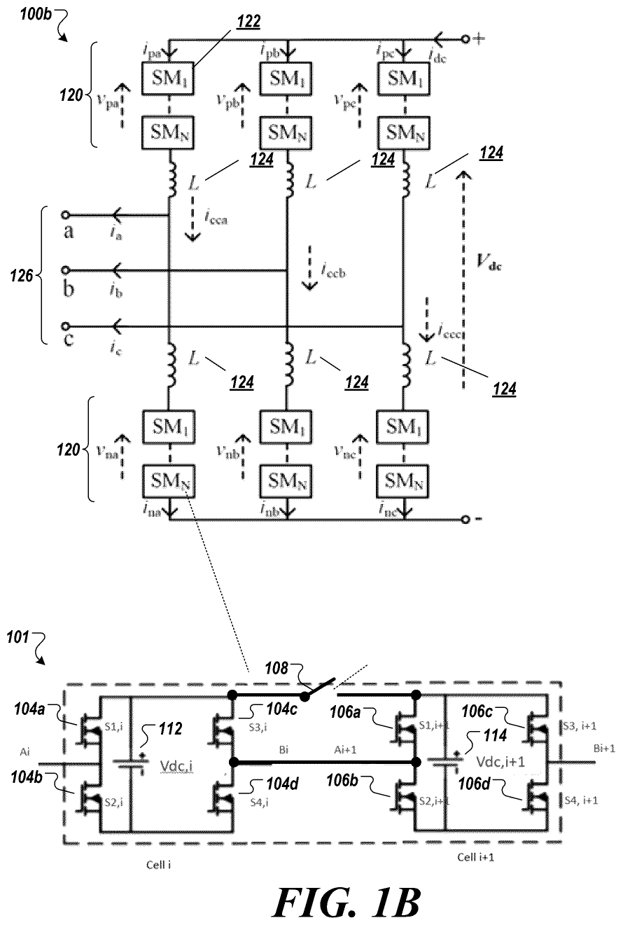

FIGS. 1A and 1B show examples of a modular, multicell, multi-level converter/inverter system 100 (shown as Cascaded H-bridge (CHB) system 100a and Modular Multilevel Converter (MMC) system 100b) configured with an H-bridge cell I (102) comprising H-bridge 104 connected by a linking switch S₅ 108 to a next H-bridge cell having H-bridge 106 to allow parallel numbers of H-bridges/cells (shown as cell i and cell i+1) to operate together in accordance with an illustrative embodiment.

The term “linking switch” can also be referred to as a H-bridge cell linking switch that includes two or more switching components. Linking switching can also be referred to as a half-bridge cell linking switch that includes at least one switching component.

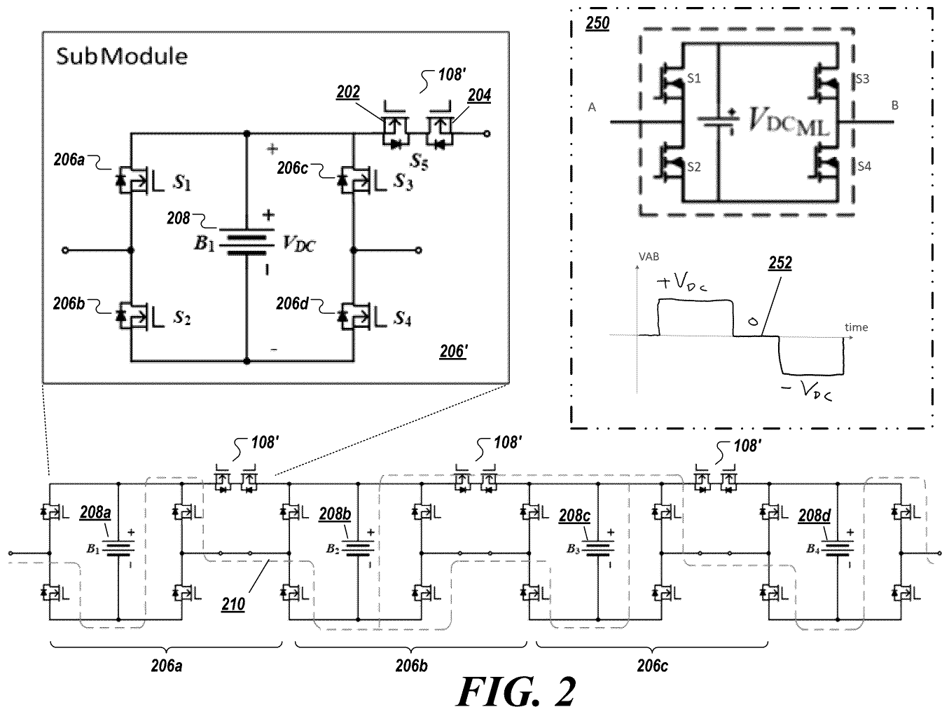

In FIG. 1A, the H-bridges 104 for a cell i include four switches, shown as S_{1,i}, S_{2,i}, S_{3,i}, S_{4,i} (104a-104d) that connect in parallel to a DC-voltage source 112, 114 and a next H-bridge 106 of a next cell i+1 having switches S_{1,i+1}, S_{2,i+1}, S_{3,i+1}, S_{4,i+1} (106a-106d). In topologies like Cascaded H-bridge and Modular Multilevel Converter (see, e.g., diagram 250, FIG. 2), when one cell is generating zero voltage (252), as directed by the system controller, the voltage source associated with that cell is not absorbing nor injecting power to the grid or the load. In the example shown in FIG. 1A, for an N-cell CHB 100a, a total N−1 linking switch S₅ 108 (shown as 108a, 108b) are employed for each phase in which each linking switch S₅ includes two switching components (110a, 110b) that can, collectively, block positive and negative voltages equal to V_{dc}. When S₅ (108) is “OFF” (diagram 101), the Cell i (104) and adjacent Cell i+1 (106) can collectively operate like traditional H-bridges in a CHB, or MMC. And, when S₅ (108) is “ON” (diagram 101′), the switch S_{3,i} (104c) of the first H-bridge cell and the switch S_{1,i+1} (106a) of the second H-bridge cell would be OPEN, and the switch S_{4,i} (104d) of the first H-bridge cell and S_{2,i+1} (106b) of the second H-bridge cell would be “ON” to put DC-source voltage V_{dci} (at source 112) of the first H-bridge cell in parallel with DC-source voltage V_{dci+1} (at source 114) of the second H-bridge cell to form a combined H-bridge cell in which the two voltage sources (112, 114) are in parallel. Circuit efficiency can also be improved by decreasing the current in each voltage source. While shown as a battery in the example, the DC source can be a battery, fuel cell, photovoltaic, or other types of DC source as described or referenced herein.

In the example shown in FIG. 1A, the modular, multicell, multi-level converter system as a Cascaded H-bridge (CHB) system 100a includes a plurality of H-bridge cells 102 (shown as 102a, 102b, . . . ) that are connected in series to connect to the grid 116. In the example, the modular, multicell, multi-level converter system 100 includes three Cascaded H-bridges 102 (shown as 102a, 102a′, and 102a″), one for each phase of a 3-phase example, that is connected to the grid 116 through a grid filter 118. Multilevel sinusoidal output voltage can be generated by the CHB by independent control of the output voltage of each cell. The sum of the cells for a given phase would follow a sinusoidal reference V_{ref} that can be provided by a controller. The Cascaded H-bridge (CHB) system 100a can be employed for other phase configurations, e.g., 1-phase, 2-phase, 3-phase, 6-phase, 12-phase, among others.

FIG. 1B shows the same topology for a H-bridge 104 of FIG. 1A in a Modular Multilevel Converter 100b. The Modular Multilevel Converter 100b includes two sets of cascading cells 120, each having a set of cells SM₁ . . . SM_{N} (122). Each cell 122 can be an H-bridge like the CHB or a half-bridge. In the example shown in FIG. 1B, the Modular Multilevel Converter 100b includes a transformer 124 to isolate the cascading cells 120 to each other and to the output 126.

### Example Operation

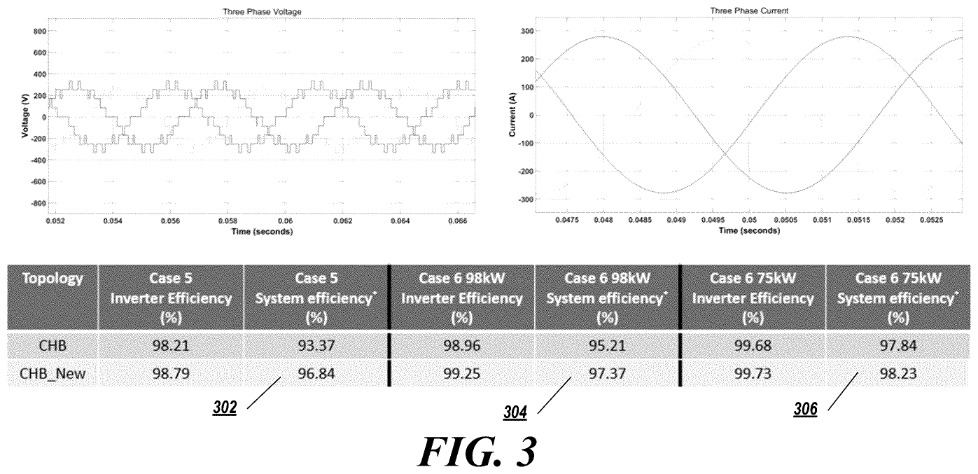

FIGS. 2 and 3 show two example operations of the modular, multicell, multi-level converter/inverter system of FIG. 1A in accordance with an illustrative embodiment. Similar operations can be applied to the modular, multicell, multi-level converter/inverter system of FIG. 1B. FIG. 2 shows an example operation of the modular, multicell, multi-level converter/inverter system 100a configured to couple to a set of batteries as voltage sources that connect to the grid (e.g., 116). FIG. 3 shows a simulation of the modular, multicell, multi-level converter/inverter system 100a to drive a motor load. The term “grid” refers to the electrical grid as an interconnected network for electricity delivery from producers to consumers and vice versa. The grid operates with three-phase alternating current (AC) frequencies synchronized to allow transmission of AC power throughout an area and provides connectivity to a large number of electrical sources (e.g., batteries, photovoltaics, generators, plug-in electric vehicles).

In the example shown in FIG. 2, the linking switches S₅ 108 (shown as 108′) of a cascading H-bridge cell 102 (shown as 206a, 206b, 206c) are shown comprising two MOSFETs (202, 204) configured to block both positive and negative voltages applied at either cell i or cell i+1. The linking switch S₅ can be implemented as MOSFETs, IGBTs, or other switches described herein.

The H-bridge cell 206 (shown as “Submodule” 206′) includes four switches S₁ 104a, S₂ 104b, S₃ 104c, S₄ 104d connected in parallel to a DC source 208 (shown as 208a, 208b, 208c, 208d) that is located between the two respective side of the H-bridge. The voltage stress or potential across the linking switch S₅ 108 equals V_{dc}.

The line 210 shows an example commutation path of the inverter. As shown, the commutation path flows across the S_{2,1}, battery 208a, S_{3,1} in cell “1” (206a); S_{2,2}, battery 208b, S_{3,2}, and linking switch S_{5,2} in cell “2” (206b); S_{2,3}, battery 208c, S_{3,3} in cell “3” (206c) to put B₂ (208b) and B₃ (208c) batteries in parallel. As discussed via diagram 250, for a typical H-bridge, when one cell is generating zero voltage (252), the voltage source associated with that cell is not absorbing nor injecting power to the grid or the load. In contrast, by linking two batteries in parallel in the modular, multicell, multi-level converter/inverter system, the voltage sources share the power to the grid or load.

FIG. 3 shows a simulation of the modular, multicell, multi-level converter/inverter system 100a to drive a motor load. The simulation was performed for 8 Cells/Modules for a 98 kW output power. The system efficiency (converter efficiency+Battery efficiency) was observed to increase by 3% (302) in Case 5 (98 kW), 2% (304) in Case 6 (98 kW), and 1% (306) in Case 6 (75 kW). For EV applications, this will translate to extra mileage for the car.

### Examples H-Bridge Cell Configurations #2-#4

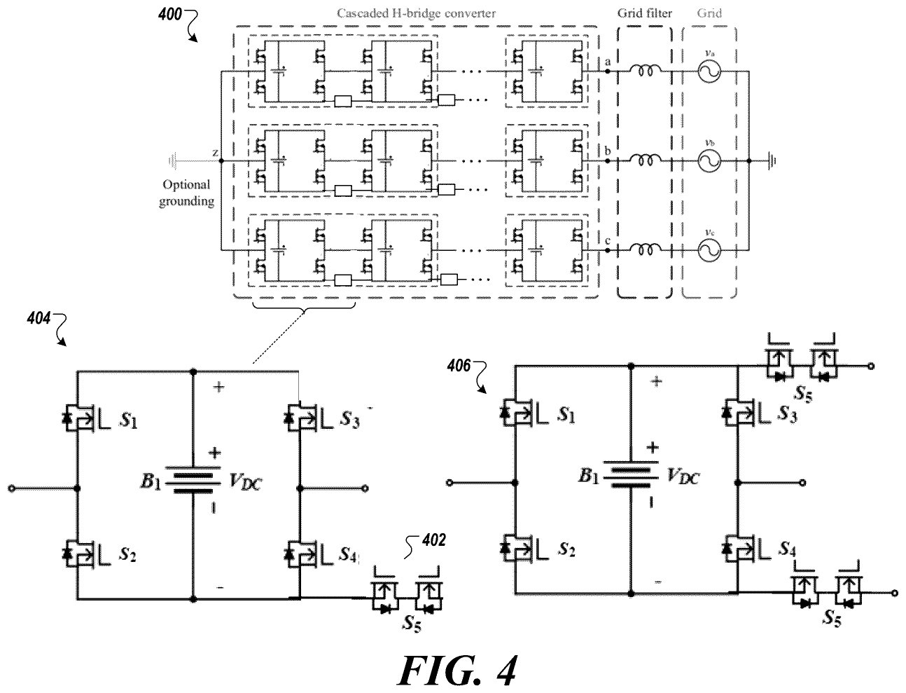

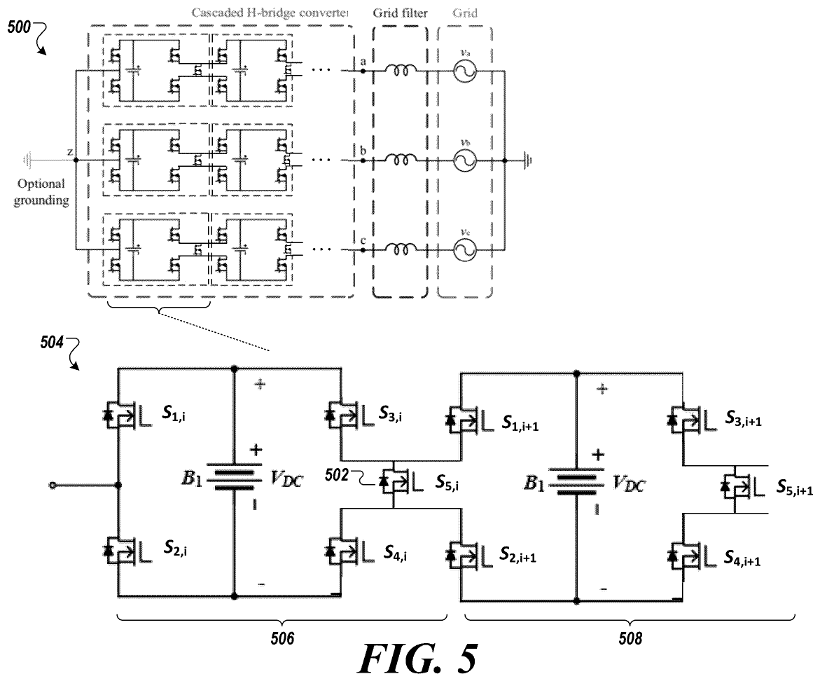

FIGS. 4 and 5 show additional examples of the modular, multicell, multi-level converter/inverter system 100 (shown as Cascaded H-bridge (CHB) system 400, 500) configured with an H-bridge cell i (102) comprising H-bridge 104 connected by a linking switch S₅ 108 (shown as 402, 502) to a next H-bridge cell to link voltage sources coupled in the respective cell in accordance with an illustrative embodiment.

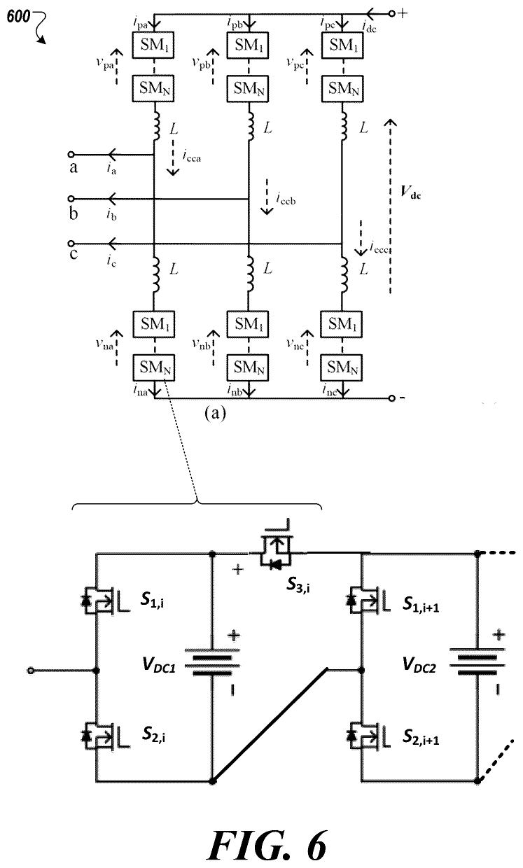

FIG. 6 shows an additional example of the modular, multicell, multi-level converter/inverter system 100 (shown as MCC 600) configured with a half-bridge cell comprising half bridge connected by a linking switch S₃ to a next half-bridge cell to link voltage sources coupled in the respective cell in accordance with an illustrative embodiment.

Example #2: Negative Bus Configuration. In FIG. 4 (and shown in further detail in diagram 404), the linking switch S₅ 108 (shown as 402) is connected in series between the H-bridge cells but at the negative bus instead of the positive bus. It is contemplated and also shown in FIG. 4, diagram 406, that the linking switch S₅ can be implemented via two sets of switching components, one set at the positive bus and the other set at the negative bus.

In the example shown in FIG. 4, the H-bridge for a cell includes four switches, shown as S₁, S₂, S₃, and S₄, that connect in parallel to a DC-voltage source and a next H-bridge in a cascading configuration. For an N-cell CHB, a total N−1 linking switch S₅ 402 can be employed for each phase in which each linking switch S₅ includes two switching components that can, collectively, block positive and negative voltages equal to V_{dc}. When S₅ (402) is “OFF”, Cell i and adjacent Cell i+1 can collectively operate like traditional H-bridges in a CHB, or MMC. And, when S₅ (402) is “ON”, the switch S₄ of the first H-bridge cell and the switch S₂ of the second H-bridge cell may be OPEN, and the linking switch S₃ of the first H-bridge cell and S₁ of the second H-bridge cell may be “ON” to put DC-source voltage V_{dc} of the first H-bridge cell in parallel with DC-source voltage of the second H-bridge cell to form a combined H-bridge cell in which the two voltage sources are in parallel.

Example #3: Parallel Configuration. In FIG. 5 (and shown in further detail in diagram 504), the linking switch S₅ 108 (shown as 502) comprises a single switching element such as a MOSFET connected in parallel between the two H-bridge cells 506 and 508.

In the example shown in FIG. 5, the H-bridge for a cell includes four switches, shown as ₁₊₁, S₂₊₁, S₃₊₁, and S₄₊₁, that connect in parallel to a DC-voltage source (shown as “B1”) and a next H-bridge in a cascading configuration. For an N-cell CHB, a total N−1 linking switch S₅ 502 can be employed for each phase in which each linking switch S₅ includes a single switching component like a MOSFET that can block positive voltage equal to V_{dc}. During normal operation, the linking switch S₅ 502 is always “ON” such that when one cell is generating zero voltage, the voltage source associated with that cell is not absorbing nor injecting power to the grid or the load. Then, to put the two DC sources in parallel, the linking switch S5 502 is “OFF,” and S_{3,I} and S_{1,i+1}, S_{4,i}, and S_{2,i+1} are “ON” to share the power of the two DC sources to the grid or load.

Example #4: Half Bridge Cell for DC/DC Converter. In FIG. 6 (and shown in further detail in diagram 604), the linking switch S₅ (602) is connected in series between two H-bridge cells, each comprising a half-bridge.

The half-bridge for a cell includes two switches, shown as S_{3,i}, that connect in parallel to a DC-voltage source and a next half-bridge in a cascading configuration. The half-bridge cell may be employed in an MMC, e.g., as described in relation to FIG. 1B. For an N-cell MCC, a total N−1 switch S₃ 602 can be employed for each phase in which each linking switch S₃. When S₃ (602) is “ON”, the switch S_{1,i+1} of the second half bridge is OFF, and the switch S_{2,i+1} of the second half bridge is “ON” to put DC-source voltage V_{dc} of the first H-bridge cell in parallel.

### Example Charge Pump DC/DC Converter

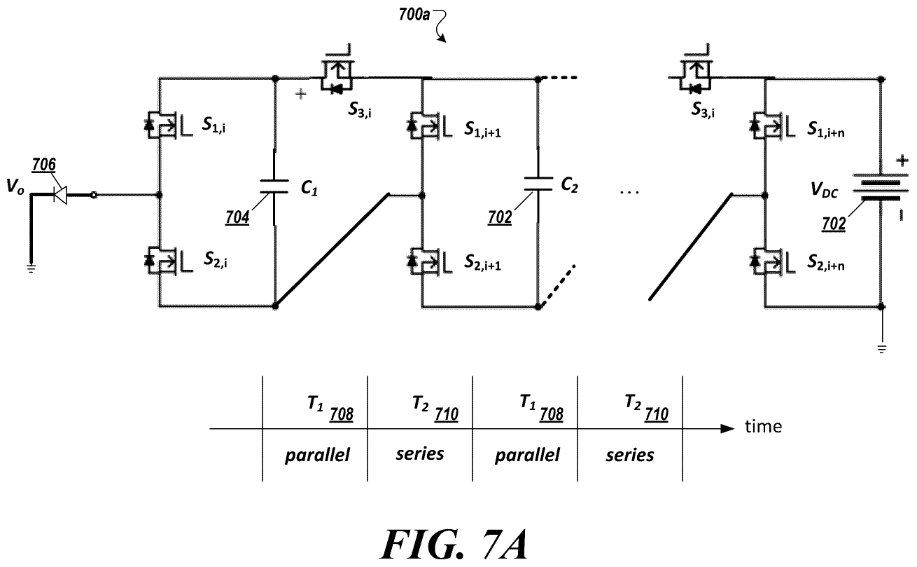

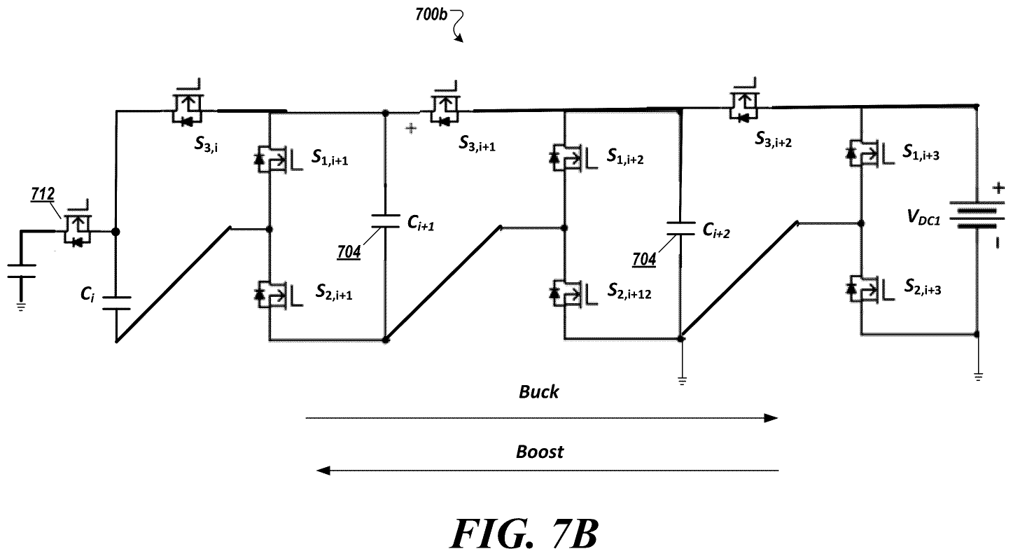

FIG. 7A shows the Modular Multilevel Converter (MMC) system 600 of FIG. 6 configured as a charge pump DC/DC converter 700a in accordance with an illustrative embodiment. FIG. 7B shows the Modular Multilevel Converter (MMC) system 600 of FIG. 6 configured as a bidirectional charge pump DC/DC converter 700b in accordance with an illustrative embodiment.

In the example shown in FIG. 7A, the charge pump DC/DC converter 700a employs a DC source V_{dc} (702) for one of the half-bridge cells, and the rest of the cells are DC capacitors (704). The charge pump DC/DC converter 700a includes a high voltage diode 706 located at the output Vₒ. Diagram 701 shows a sequence of operation for the charge pump DC/DC converter 700a.

During “T1” (708), the linking switch S3 is enabled to connect all capacitors in parallel with the DC source V_{dc} as described in relation to FIG. 6. During “T2” (710), all DC capacitors and DC voltage source are placed in series to generate a high output voltage. The charge pump DC/DC converter 700a can be configured to operate at T1=T2=0.5T, where T=1/f is the switching frequency. By increasing the number of cells, the output voltage can be very high.

In DC/DC applications, the first two switches S_{1,i} and S_{2,i} in the first cell are redundant and thus can be omitted to provide a final circuit with N−1 capacitors, one Vdc source, N−1 half bridges, and N−1 linking switch S₃. The output Vₒᵤₜ of the charge pump can be determined as N*V_{dc}.

Bidirectional charge pump DC/DC converter. FIG. 7B shows the Modular Multilevel Converter (MMC) system 100b of FIG. 6 configured as a bidirectional charge pump DC/DC converter 700b having N=4 cells in accordance with an illustrative embodiment. The diode 706 of FIG. 7A is substituted with a high voltage switch 712, such as a high voltage SiC MOSFET, to provide bidirectional power flow. The bidirectional charge pump DC/DC converter is configured as a boost converter when operating in a first current flow and as a buck converter when operating in a second current flow.

### Example Bidirectional DC-AC/AC-DC Inverter

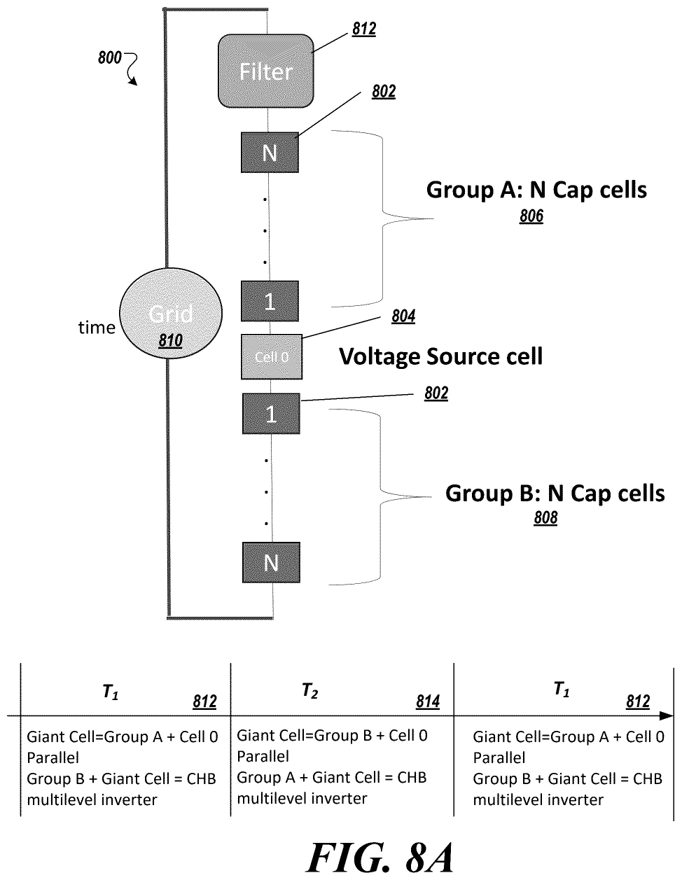

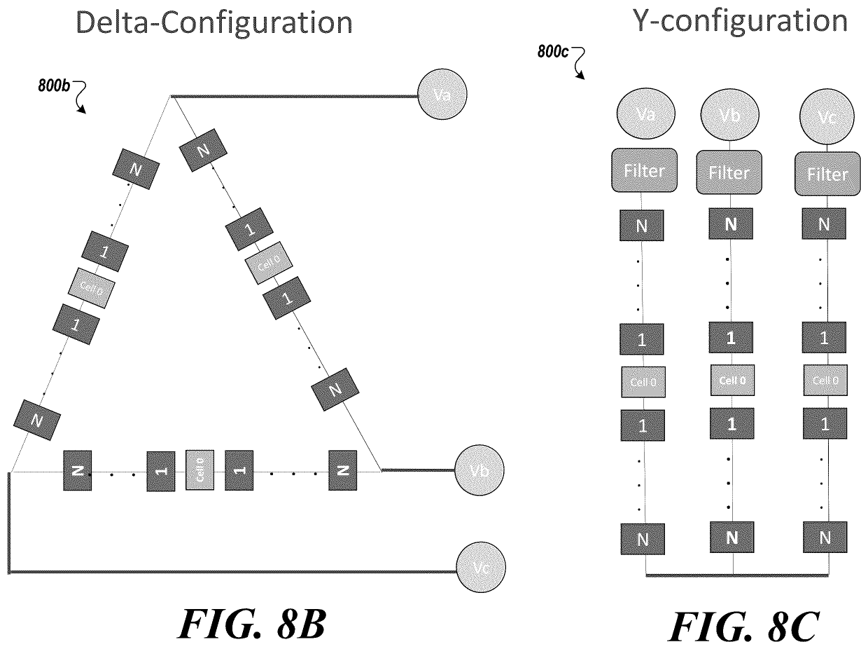

FIG. 8A shows the CHB system (e.g., 100a) of FIGS. 1A, 1B, 2, 3, and 4, configured as a bidirectional DC-AC and AC-DC inverter/rectifier 800 in accordance with an illustrative embodiment. FIGS. 8B and 8C show the multiples of the bidirectional DC-AC and AC-DC inverter/rectifier 800 of FIG. 8A configured for 3-phase operation in accordance with an illustrative embodiment.

In the example shown in FIG. 8A, the inverter 800 includes 2N+1 H-bridge cells 102 (shown as 802), e.g., as described in relation to FIG. 1A, 1B, 2, 3, or 4. The inverter 800 includes a voltage source cell 804 (shown as “Cell 0” 804) in the middle of the chain of cascading H-bridge cells (1, . . . , N). The rest of the 2N cells may be configured with capacitors. The cascading H-bridge cells can be grouped into groups, shown as “Group A” 806 and “Group B” 808. The V_{AB} voltage is a sinusoidal voltage with controllable magnitude and frequency. The converter can function as a bidirectional DC/AC inverter and AC/DC rectifier and is connected to single-phase grid 810.

The inverter 800 may be configured with a grid filter 812, e.g., that includes an inductor L or an LCL filter.

The total number of switches in the inverter 800 may be determined as

$$( 2 N + 1 ) * 4 + ( 2 N + 11 ) * 2 = 12 N + 4 .$$

Example Operation. In one configuration, N capacitors are employed with N+1 cascading H-bridge cells to form a multilevel CHB inverter. During operation, at time “T1” (812), the voltage source cell Cell 0 is in parallel with the N cells of Group A (806), so the voltage source is charging N capacitors that are configured to be in parallel via the linking switch S₅ operation. At the same time, Group B cells and the paralleled giant cell of Group A form a CHB converter to generate positive and negative AC voltages. During the time “T2” (814), the voltage source cell Cell 0 is in parallel with the N cells of Group B (808) to allow the voltage source (804) to charge its N capacitors since they are in parallel. At the same time, Group A cells and the paralleled giant cell of Group B form a CHB converter to generate positive and negative AC voltages. The operation then repeats. The inverter 800 can be configured to operate at T1=T2=0.5T, where T=1/f is the switching frequency. Higher frequency f can beneficially reduce the capacitor size in Group A (806) and Group B (808).

3 Phase Configurations. FIGS. 8B and 8C show a system (shown as 800b, 800c) having multiples of the bidirectional DC-AC and AC-DC inverter/rectifier of FIG. 8A, including a first inverter 822, a second inverter 824, and a third inverter 826, configured for 3-phase operation in accordance with an illustrative embodiment. Each of the inverters 822, 824, and 826 includes a set of cascading H-bridge cells that has the linking switch S₅ to link the capacitors of the respective H-bridge cells in parallel.

FIG. 8B shows the system 800b with the multiples of the bidirectional DC-AC and AC-DC inverter/rectifiers configured in a delta configuration. FIG. 8C shows the system 800c with the multiples of the bidirectional DC-AC and AC-DC inverter/rectifiers configured in a delta configuration. The inverter system 800b and 800c may optionally include grid side filter L or LCL, among other filters described or referenced herein.

### Example Phase Inverter with Half Bridge Cells

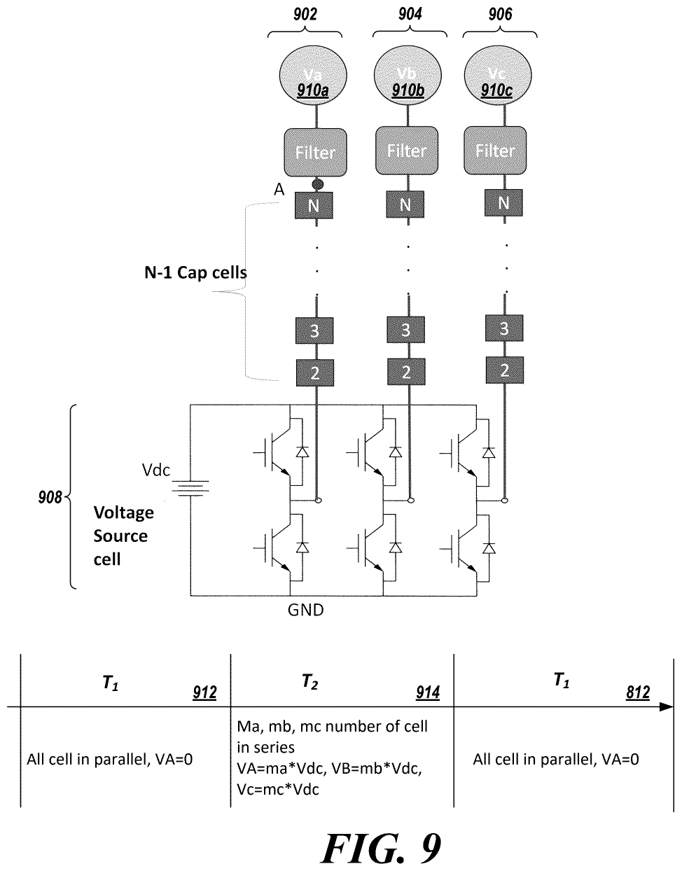

FIG. 9 shows cascading half-bridge cells, e.g., as described in relation to FIG. 6, configured as a bidirectional 3-phase inverter 900 in accordance with an illustrative embodiment.

Three cascading half-bridge cells (902, 904, 906) are each configured as a charge pump converter to voltage source 910 (shown as 910a, 910b, 910c) in which the half-bridge for a cell, e.g., as described in relation to FIG. 6, includes two switches, e.g., S_{3,i}, that connect in parallel to (i) a DC-voltage source having a capacitor and (ii) a next half-bridge in a cascading configuration. When S₃ is “ON”, the switch S_{1,i+1} of the second half bridge is OFF, and the switch S_{2,i+1} of the second half bridge is “ON” to put DC-source voltage V_{dc} of the first H-bridge cell in parallel.

The bidirectional 3-phase inverter 900 includes a 6-switch 2-level converter 608 to which the charge pumps 902, 904, and 906 terminate.

The bidirectional 3-phase inverter 900 can connect to the grid in delta configuration to provide DC-to-AC and/or AC-to-DC operation.

During operation, the voltages V_{A}, V_{B}, and V_{C}, in reference to the ground GND, each has N levels, e.g., 0, +V_{dc}, +2V_{dc}, . . . , N*V_{dc}. The voltages are all positive voltages.

For Phase A (910a), as well as Phases B and C, during “T1” (912), all cells are placed in parallel per the operation of the linking switch S₃, e.g., as described in relation to FIG. 6, so the source voltage V_{dc} is charging the cell capacitors. In this case, V_{A}=0V. Then, during “T2” (914), the number of cells m are placed in series based on AC voltage reference (e.g., V_{refa} for phase A; V_{refb} for phase B, and V_{refc} for phase C). In this case, Vₐ=m*V_{dc}. The inverter 900 can be configured to at operate at T1=T2=0.5T, where T=1/f is the switching frequency. Additionally, “T1” (912) and “T2” (914) can be determined by a Pulse Width Modulation (PWM) operation. When T1=T2=½T, the average voltage V_{A} can be determined as ½ m×V_{dc}. Because the maximum value of m is N, the maximum average voltage can be calculated as ½ N×V_{dc}.

Because only positive voltage is generated, a DC offset voltage may be formed that can be determined as ½ N×½ V_{dc}=¼ N×V_{dc}. This means the effective grid voltage has to be lower, or the modulation index is low.

Phase B and Phase C operations are similar to that of Phase A, though with T1 and T2 clock that is phase shifted. Mₐ, M_{b}, M_{c} can be generated independently based on V_{refa}, V_{refb}, V_{refc}

### CONCLUSION

Throughout the description and claims of this specification, the word “comprise” and other forms of the word, such as “comprising” and “comprises,” means including but not limited to, and are not intended to exclude, for example, other additives, segments, integers, or steps. Furthermore, it is to be understood that the terms comprise, comprising, and comprises as they relate to various aspects, elements, and features of the disclosed invention also include the more limited aspects of “consisting essentially of” and “consisting of.”

As used herein, the singular forms “a,” “an,” and “the” include plural referents unless the context clearly dictates otherwise. Thus, for example, reference to a “polymer” includes aspects having two or more such polymers unless the context clearly indicates otherwise.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

For the terms “for example” and “such as,” and grammatical equivalences thereof, the phrase “and without limitation” is understood to follow unless explicitly stated otherwise.

The following patents, applications and publications as listed below and throughout this document are hereby incorporated by reference in their entirety herein.

### REFERENCE LIST

[1] C. Terbrack, J. Stöttner and C. Endisch, “Design and Validation of the Parallel Enhanced Commutation Integrated Nested Multilevel Inverter Topology,” in IEEE Transactions on Power Electronics, vol. 37, no. 12, pp. 15163-15174, December 2022, doi: 10.1109/TPEL.2022.3183859.

What is claimed is:

1. A modular, multicell, multi-level power conversion system comprising:
a set of cascading H-bridge cells, including a first H-bridge cell and a second H-bridge cell, each of the first and second H-bridge cell as a modular unit cell including:
four switches arranged in a H-bridge configuration;
terminals to a DC power source, the terminals located parallel to the H-bridge configuration; and
a fifth switch connecting the modular unit cell to a next unit cell in the set of cascading H-bridge cells, wherein the fifth switch, along with the respective four switches of the modular unit cell and the next modular unit cell, are configured to collectively form a new H-bridge between them that links together the respective terminals to the DC power sources of the modular unit cell and the next modular unit cell in a parallel connection.

2. The modular, multicell, multi-level power conversion system of claim 1, wherein the fifth switch is connected in series along a positive bus located between the first H-bridge cell and the second H-bridge cell.

3. The modular, multicell, multi-level power conversion system of claim 1, wherein the fifth switch includes at least one of: (i) two MOSFETs or (ii) two IGBTs, arranged to block current flow in a first direction from the modular unit cell to the next modular unit and a second direction from the next modular unit cell to the modular unit.

4. The modular, multicell, multi-level power conversion system of claim 1, wherein the fifth switch is connected in series along a negative bus located between the first H-bridge cell and the second H-bridge cell.

5. The modular, multicell, multi-level power conversion system of claim 1, wherein the fifth switch is connected in parallel between the first H-bridge cell and second H-bridge cell.

6. The modular, multicell, multi-level power conversion system of claim 1, wherein the system is configured as an N-cell CHB or N-cell MMC, the system comprising N−1 number of the fifth switches.

7. The modular, multicell, multi-level power conversion system of claim 6, wherein a controller of the fifth switches is configured to, based on a target output voltage for a DC/AC conversion, direct a number of fifth switches to be enabled to link the respective terminals to the DC power sources of the modular unit cell and the next modular unit cell of the cascading network in parallel connections.

8. The modular, multicell, multi-level power conversion system of claim 7, wherein cells of the set of cascading half-bridge cells are selected to operate based on equal utilization of the fifth switches.

9. A modular, multicell, multi-level power conversion system comprising:
a set of cascading half-bridge cells, including a first half-bridge cell and a second half-bridge cell, each of the first and second half-bridge cell as a modular unit cell including:
two switches arranged in a half-bridge configuration;
terminals to a DC power source, the terminals located parallel to the half-bridge configuration; and
a third switch that connects the modular unit cell to a next modular unit cell in the set of cascading half-bridge cells, wherein the third switch and the respective two switches of the modular unit cell and the next modular unit cell are configured to operate to collectively form a new half-bridge between the modular unit cell and the next modular unit cell that links together the respective terminals to the DC power sources of the modular unit cell and the next modular unit cell in parallel connection.

10. The modular, multicell, multi-level power conversion system of claim 9, wherein the terminals to the DC power source of the first half bridge cell are configured to couple to a DC source, and wherein the terminals to the DC power source of the second half bridge cell and the other half bridge cells are configured to couple to a DC capacitor, and the circuit is configured to form a charge pump DC/DC converter.

11. The modular, multicell, multi-level power conversion system of claim 10, wherein the charge pump DC/DC converter includes a diode and a capacitor at the output of the last half-bridge cell.

12. The modular, multicell, multi-level power conversion system of claim 9, wherein the terminals to the DC power source of the first half-bridge cell are configured to couple to a DC source, and wherein the terminals to the DC power source of the second half-bridge cell and the other half-bridge cells are configured to couple to a DC capacitor, and the circuit is configured to form a bi-directional charge pump DC/DC converter, wherein a switch and a capacitor is connected to the output of the last half bridge cell.

13. The modular, multicell, multi-level power conversion system of claim 12, wherein the bidirectional charge pump DC/DC converter is configured as a boost converter when operating in a first current flow direction and as a buck converter when operating in a second current flow.

14. The modular, multicell, multi-level power conversion system of claim 13 further comprising:
a second charge pump DC/DC converter and a third charge pump DC/DC converter; and
a 6-switch 2-level converter, wherein the 6-switch 2-level converter terminates the charge pump DC/DC converter, the second charge pump DC/DC converter, and the third charge pump DC/DC converter, as a 3-phase inverter,
wherein the 6-switch 2-level converter is coupled to a single DC source, and
wherein the converter is configured to operate as a DC/AC three-phase inverter with an output voltage higher than the DC source voltage.

15. A modular, multicell, multi-level power conversion system comprising:
a set of cascading H-bridge cells, including a first H-bridge cell and a second H-bridge cell, each of the first and second H-bridge cell as a modular unit cell including:
four switches arranged in a H-bridge configuration;
terminals to a DC power source, the terminals located parallel to the H-bridge configuration; and
a fifth switch connecting the modular unit cell to a next unit cell in the set of cascading H-bridge cells, wherein the fifth switch, along with the respective four switches of the modular unit cell and the next modular unit cell, are configured to collectively form a new H-bridge between them that links together the respective terminals to the DC power sources of the modular unit cell and the next modular unit cell in a parallel connection;
a first set of cascading H-bridge cells, including the first and second H-bridge cells, wherein the DC terminals of the first set of cascading H-bridge cells are connected to a respective capacitor bank;
a second set of cascading H-bridge cells, including a third H-bridge cell and a fourth H-bridge cell, where the DC terminals of the second set of cascading H-bridge cells are connected to a respective capacitor bank; and
an additional H-bridge cell that is coupled to a DC voltage source,
wherein the first set of cascading H-bridge cells, the second set of cascading H-bridge cells, and the additional H-bridge cell collectively form an inverter.

16. The modular, multicell, multi-level power conversion system of claim 15 further comprising a grid filter on the AC side of the converter.

17. The modular, multicell, multi-level power conversion system of claim 15, wherein a controller is configured to perform magnitude and frequency control for the modular, multicell, multi level power conversion system.

18. The modular, multicell, multi-level power conversion system of claim 15, further comprising:
a second inverter, and a third inverter, each of the second and third inverter comprising:
two sets of cascading H-bridge cells, including a first respective and a second respective cascading H-bridge cells; and
an additional H-bridge cell that is coupled to a DC voltage source,
wherein the inverter, second inverter, and third inverter are connected in a delta- or Y-configuration for 3-phase operation.

19. The modular, multicell, multi-level power conversion system of claim 18, wherein the additional H-bridge cells DC terminal is coupled to a load, forming a single-phase AC/DC rectifier or three-phase AC/DC rectifier.
